(19) United States
(12) Patent Application Publication
(10) Pub. No.: US 2025/0273390 A1
(43) Pub. Date: Aug. 28, 2025

(54) Transformer with improved insulation

(71) Applicant: Ravisekhar Raju, Clifton Park, NY (US)

(72) Inventor: Ravisekhar Raju, Clifton Park, NY (US)

(21) Appl. No.: 18/585,049

(22) Filed: Feb. 22, 2024

(51) Int. Cl. H01F 27/32

(52) U.S. Cl. CPC H01F 27/324; H01F 2027/329

(57) ABSTRACT

A transformer with improved insulation is provided with an electrically insulating sheet separating the primary winding and a first split-core section from the secondary winding and a second split-core section. The insulating sheet is provided with coatings and the coatings are referenced to the primary side and the secondary side windings and cores to form equipotential surfaces and distribute the dielectric stresses across the transformer. Ridges are optionally added to the insulation sheet to increase creepage and clearance distances. The features described reduce the occurrence of corona and partial discharge in the transformer structure and surrounding space.

### CROSS-REFERENCE TO RELATED APPLICATION

This application claims the benefit of U.S. Provisional Patent Application No. 63/447,086, filed 21 Feb. 2023, which is incorporated by reference herein in its entirety.

### BACKGROUND

The present invention relates to the field of electric power and transformers. Specifically, the present invention relates to improved insulation for transformers. More specifically the present invention relates to an improved insulation structure for medium or high frequency transformers that are used to provide compact galvanic isolation and voltage step-up or step-down in power conversion applications.

U.S. Pat. No. 11,735,357, granted to the applicant, describes a transformer with improved insulation structure. The present invention describes novel enhancements to further improve the insulation of a transformer.

Transformers are widely used in electric power systems for functions such as step-up or step-down of voltages. They are also widely used along with power semiconductors to provide power electronic conversion with galvanic isolation in switch-mode power supplies, such as laptop computer adapters, phone chargers, and electric vehicle chargers. In these switch-mode power supplies, incoming line frequency AC which is typically 50 or 60 Hz is converted to high frequency through fast-switching transistors and fed to transformers for step-down followed by rectification to DC. Here high frequency refers to a frequency greater than the line frequency with typical applications being in the kHz or even a few MHz range. Generally, high frequency operation instead of line frequency operation can reduce the size and weight of the transformer since a smaller magnetic core can be used.

Although the transformer core size can be reduced with high frequencies, providing adequate insulation between the primary and secondary sides of the transformer is a challenge, particularly for high voltage or grid-connected application. Oil is often used as an insulating medium due to good thermal and dielectric properties. In dry-type transformers, materials such as epoxy, paper, Nomex® sheets and Kapton® tape are used as insulating media.
In many applications, oil-filled transformers are not preferred due to issues such as flammability or possibility of leaks. Dry-type transformers are susceptible to partial discharge breakdown particularly if there are voids or pockets of air in the insulating material such as epoxy. They are also generally more difficult to manufacture and costlier than oil-filled transformers for high power applications.
Therefore, what is needed are techniques that overcome the above mentioned disadvantages.

### BRIEF SUMMARY OF THE INVENTION

Embodiments of the invention provide a transformer with improved insulation. In particular, the invention provides an improved insulation for medium or high frequency transformers wherein the primary and secondary voltages are in the range of few volts to kilovolts and the isolation required between the primary and secondary sides is in the few kilovolts to tens of kilovolts. Such transformers can be used in concert with power semiconductor switching devices to develop modular power electronic building blocks for power transmission, distribution and processing applications.

In accordance with a first embodiment of the invention, a transformer comprises a primary side winding and a secondary side winding with a substantially high electric potential difference between the two sides. An electrically insulating sheet is placed between the two sides. The transformer further comprises a magnetic core to couple the windings, with the magnetic core split into two sections, one placed on the primary side of the insulating sheet and the second placed on the secondary side of the insulating sheet. The insulating sheet has a conductive or semiconductive coating on its surface facing the secondary side of the transformer and the said coating is electrically connected or referenced to the secondary winding and split core section proximal to the secondary winding such that they are all at substantially equal potential. An optional protective coating can be added to protect the conductive or semiconductive coating. In addition, the insulating sheet has a conductive or semiconductive coating on the central portion of its surface facing the primary side of the transformer and the said coating is electrically connected or referenced to the primary winding and split core section proximal to the primary winding such that they are all at substantially equal potential. An additional conductive or semiconductive coating is placed across the periphery of the insulating sheet on the primary side and this coating is electrically connected to the conductive or semiconductive coating on the secondary side of the insulating sheet. An additional semiconductive or resistive or non-linear resistive coating is placed on the primary side of the insulating sheet surface between the aforementioned coatings in the center and on the periphery of the sheet. An optional protective coating can be added on top to protect the aforementioned coatings on the primary side. The coatings on the insulating sheet surface and their aforementioned electrical referencing to the windings and core sections substantially reduces the occurrence of corona and partial discharge in the surrounding spaces and voids in the transformer structure.

In accordance with a second embodiment of the invention, at least two insulating sheets are sandwiched between the primary and secondary sides instead of the one insulating sheet mentioned in the first embodiment with the conductive/semiconductive/resistive/non-linear resistive coating structure repeated for both the insulating sheets. The sheets are sized and stacked such that the conductive/semiconductive coating on the surface of one sheet maintains contact with the conductive/semiconductive coating on the surface of the next sheet, such that they are substantially at equipotential thus reducing dielectric stress in any spaces between them.

In accordance with yet another embodiment of the invention, ridges or fins are provided on the surface of the insulating sheet separating the primary and secondary sides of the transformer such that the clearance and creepage distance between the primary and secondary windings and core sections are increased such that the possibility of corona or electrical breakdown is reduced.

The notation of one winding or transformer side as primary and another as secondary in the previous description can be reversed.

Various other features and advantages will be made apparent from the following description and the drawings.

### BRIEF DESCRIPTION OF THE DRAWINGS

The present invention is illustrated by way of example and not limitation in the figures of the accompanying drawings in which like references indicate similar elements.

FIG. 1 illustrates a transformer with high isolation according to prior art.

FIG. 2 illustrates a transformer with an insulating sheet separating the primary and secondary sides with various features according to one embodiment of the present invention.

FIG. 3 illustrates a transformer with a sandwich of insulating sheets separating the primary and secondary sides with various features, according to another embodiment of the present invention.

FIG. 4 illustrates a transformer, according to another embodiment of the present invention, with one or more insulating sheets separating the primary and secondary sides and one or more fins or ridges added to the insulation sheet to increase the electrical creepage and clearance distance. Some features described in earlier figures have not been repeated in this figure and can be added to the structure.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention.

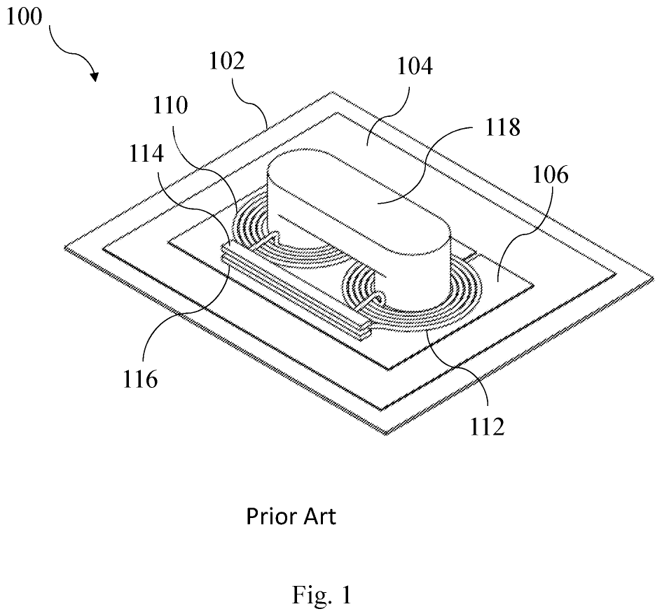

FIG. 1 illustrates a transformer, 100, according to prior art, wherein an insulating sheet, 102, made of a material such as mica with a high dielectric stress separates the primary and secondary sides of the transformer. The magnetic core of the transformer is split into two sections, a primary side core (118) and a secondary side core that is placed below the insulating sheet and not visible in the figure. The insulating sheet separates the primary side core, 118, and primary winding, 110, 112, from the secondary side core and a secondary winding, placed below the insulating sheet, 102, in the figure. Terminals 116 provide connection to the primary windings. The insulating sheet, 102, is provided with coatings, 104 and 106, to distribute dielectric stress.

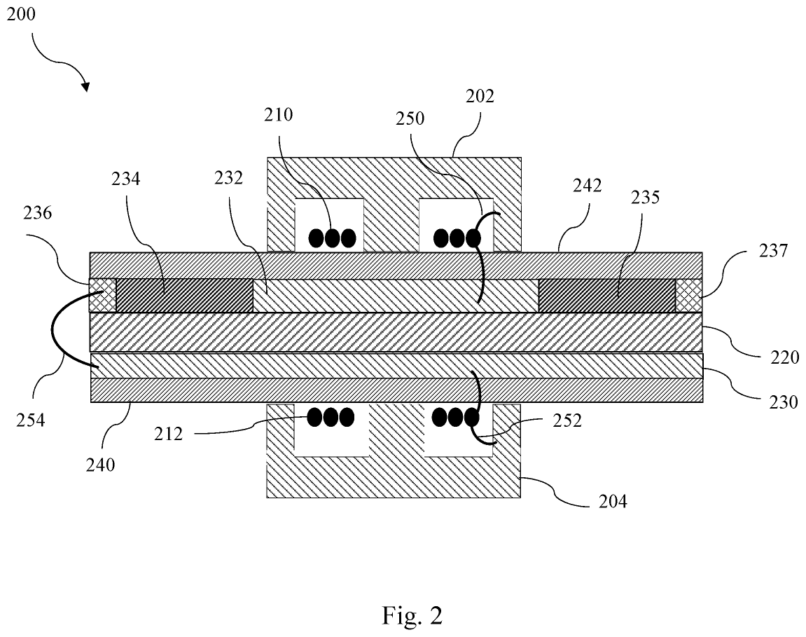

FIG. 2 illustrates, according to one embodiment of the present invention, an improved electrical insulation system, 200, wherein the magnetic core of the transformer is split into two portions, 202 and 204. Split-core section 202 is associated with the primary winding 210, while split-core section 204 is associated with the secondary winding, 212. The primary-side and secondary-side split-core sections and windings are separated by an insulating sheet 220 made of a material with high dielectric strength such as mica. In the illustration, the primary side is assumed to be the high voltage side and the secondary side is assumed to be at a lower voltage. The insulating sheet, 220, is provided on the secondary-facing side with a layer or coating 230 of a moderately electrically conductive or semiconductive material. The conductivity of the material for 230 is selected to limit eddy current losses due to transformer magnetic flux, while providing sufficient conductivity. An example material that can be used is a 1-5 mil thick layer of conductive carbon 838AR supplied by MG Chemicals. A protective coating, 240 can be used to prevent damage to layer 230 during assembly or operation of the transformer. On the primary-facing side of the insulating sheet, 220, a moderately conductive or semiconductive coating, 232, is provided in the central portion where the primary-side split-core and winding are located. A second coating, 234, of a semiconductive or resistive or non-linear resistive material is placed on the periphery of 232and extending towards the edge of the insulating sheet 220. The material of coating 234 is more resistive than that of coating 232 and is used to control the dielectric stress across the sheet, 220, from the central portion towards the periphery. A conductive coating or band, 236 and 237 is placed on the edge of the sheet 220 and provides an electrical connection, 254 between the primary-side coating 234 and the secondary-side coating, 230. The length of the coating 234 along the surface of sheet 220 can be 4-10 inches for handling voltages up to 15 kV that are typically used in electric distribution grids or industrial equipment. A protective layer 242 is provided to prevent damage to the coatings 232, 235 and 237 during the transformer assembly or operational life. The primary-side windings and core section are electrically referenced/tied, 250, to the coating 232. In a similar fashion, the secondary-side windings and core section are electrically referenced/tied, 252 to the coating 230. This electrical referencing places the primary-to-secondary voltage potential gradient substantially across the insulating sheet 220, and reduces dielectric stress in the voids or air gaps near the windings. This reduces the possibility of corona or partial discharge in these voids or air gaps and improves the reliability of the transformer.

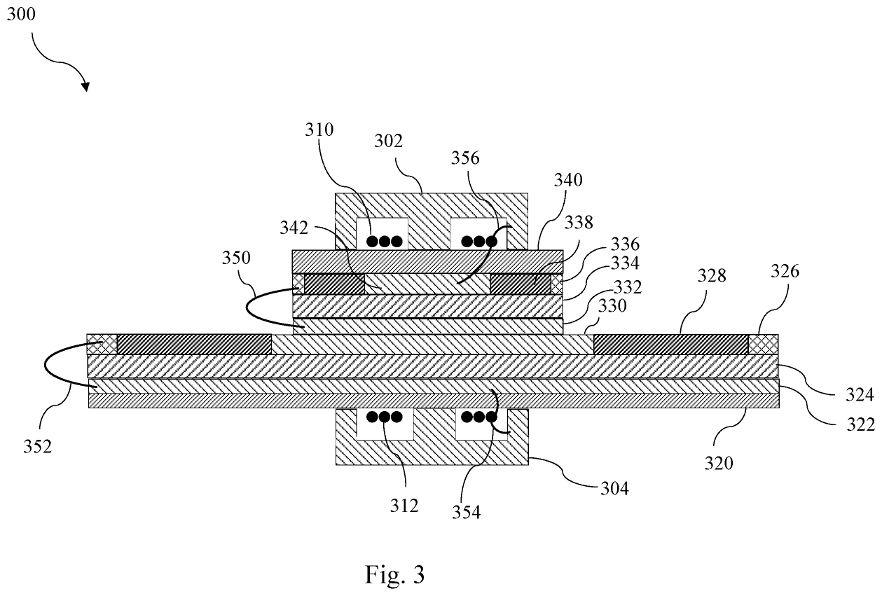

FIG. 3 illustrates a transformer, 300, with improved insulation according to another embodiment of the present invention. The structure is similar to the one in FIG. 2, with the enhancement being in the repeated stacking of the insulation and stress-grading coatings. In the illustration, conductive/semiconductive layers 342, 332, 330, and 322, and semiconductive/resistive layers 338 and 328 along with the electrical ties 350 and 352, divide the total potential difference between the primary and secondary windings into two halves with insulation sheets 324 and 332 each withstanding half the voltage. This allows the use of two thinner insulation sheets versus one single sheet to block the full voltage. Thinner insulation sheets typically have a better dielectric strength/mm than thicker sheets. This is due to the difficulty in manufacturing thick insulation sheets without voids and material defects. The structure shown in FIG. 3 shows two distributed layers of insulation stacking, but this can be extended to a higher number of layers to allow the use of even thinner insulation sheets with improved performance and cost.

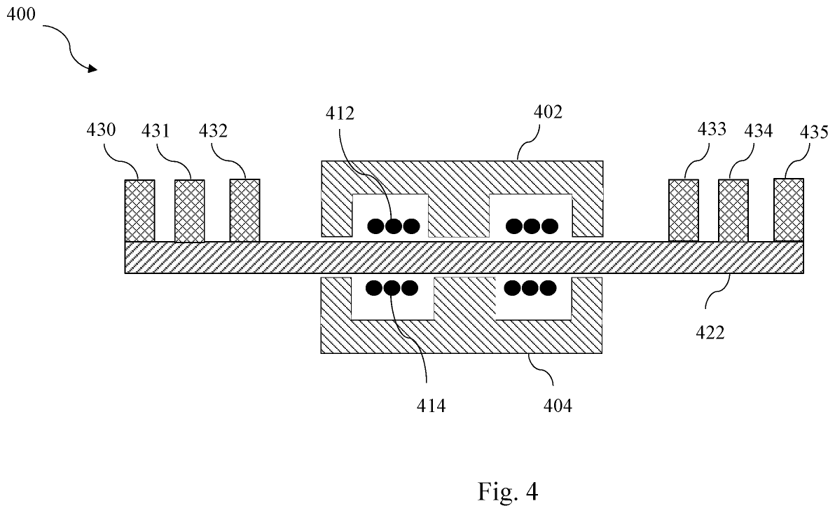

FIG. 4 illustrates, according to another embodiment of the present invention, a transformer, 400, with improved insulation. An insulating sheet, 422, separates primary-side split-core, 402 and primary winding, 412 from the secondary-side split-core, 404, and secondary winding, 414. Ridges, 430, 431, 432, 433, 434, and 435 of a high insulation strength material are placed on the insulating sheet, 422 to increase the creepage and clearance distance and reduce the possibility of dielectric breakdown. The ridges can be an integral part of the insulating sheet, 422.

The foregoing description of exemplary embodiments of the invention has been presented for the purposes of illustration and description. It is not intended to be exhaustive or to limit the invention to the precise forms disclosed. It will be recognized by those skilled in the art that many modifications and variations are possible without departing from the essential scope of the invention. It is, therefore, to be understood that the scope of the invention is not limited to the particular embodiments disclosed, and that the invention will include all embodiments falling within the scope of the claims appended hereto.

What is claimed is:

1. A transformer comprising a primary winding, a secondary winding, and a core coupling the windings;
wherein the core is partitioned to comprise a primary-side section and a secondary-side section; and
wherein an electrically insulating structure comprising an insulating sheet separates the windings and core section positioned on the primary side from the windings and core section positioned on the secondary side; and
wherein the insulating sheet is coated with a conductive or semiconductive layer on a substantially central portion of its primary-side surface where the primary-side winding and core are positioned and said layer on primary-side surface is electrically referenced to said windings and core on primary side; and
wherein the insulating sheet is coated on its primary-side surface with a semiconductive or resistive or non-linear resistive layer extending from the edge of the aforementioned coating on the central portion to substantially near the periphery of the primary-side surface; and
wherein the insulating sheet is coated with a conductive or semiconductive layer on its secondary-side surface and said layer on the secondary-side surface is electrically referenced to the transformer windings and core on the secondary side; and
wherein the said semiconductive or resistive or non-linear resistive layer on the primary side surface of the insulating sheet extending to the edge of the said surface is electrically connected substantially near the said edge to the conductive or semiconductive layer on the secondary-side surface of the insulating sheet either through another strip of conductive or semiconductive coating on the surface or through a conductive element.

2. A transformer comprising a primary winding, a secondary winding, and a core coupling the windings;
wherein the core is partitioned to comprise a primary-side section and a secondary-side section; and
wherein an electrically insulating structure comprising a stack of insulating sheets separates the windings and core section positioned on the primary side from the windings and core section positioned on the secondary side; and
wherein the individual sheets comprising the stack of insulating sheets are coated with conductive, semiconductive, resistive, or non-linear resistive layers on their surfaces; and
wherein the said conductive, semiconductive, resistive, or non-linear resistive layers on the surfaces of the individual sheets in the stack of insulating sheets are electrically connected or referenced to the conductive, semiconductive, resistive, or non-linear resistive layers on the surfaces of the adjacent sheet or to the primary or secondary side windings or core to control the dielectric stress distribution in the transformer.

3. The transformer of claim 1;
wherein the insulating sheet has ridges or fins positioned around the primary or secondary side of the transformer.

4. The transformer of claim 2;
wherein the stack of insulating sheets has ridges or fins positioned around the primary or secondary side of the transformer.
